(19) United States
(12) Patent Application Publication
(10) Pub. No.: US 2016/0231733 A1
(43) Pub. Date: Aug. 11, 2016

(54) PROGRAM CREATION DEVICE, PROGRAM CREATION METHOD, AND PROGRAM

(71) Applicant: MITSUBISHI ELECTRIC CORPORATION, Tokyo (JP)

(72) Inventors: Tatsuya NAGATANI, Tokyo (JP); Teruaki TANAKA, Tokyo (JP); Hideaki MINAMIDE, Tokyo (JP); Kimihiro MIZUNO, Tokyo (JP); Yo TAKAHASHI, Tokyo (JP); Makoto NISHIMURA, Tokyo (JP)

(73) Assignee: Mitsubishi Electric Corporation, Tokyo (JP)

(21) Appl. No.: 15/023,445

(22) PCT Filed: Oct. 31, 2013
(86) PCT No.: PCT/JP2013/079559

§ 371 Date: Mar. 21, 2016

(51) Int. Cl. G05B 19/4097; G06F 3/0482; G06F 3/0484

(52) U.S. Cl. CPC G05B 19/4097; G06F 3/04847; G06F 3/0482; G06F 3/04842; G05B 2219/35134

(57) ABSTRACT

A program creation device includes a processing unit that displays, on a display device, an edit screen on which respective timing charts of controlled units are arrayed in the vertical direction. Upon reception of a first input for designating an arrangement position of a display object on the timing charts to arrange the display object at the arrangement position, the processing unit displays the display object at the arrangement position designated by the first input on the timing charts. After displaying the display object, the processing unit receives a second input including a designation of a type and an input of a parameter. The processing unit then generates an operation program for executing an operation command of the type designated by the second input, to which the parameter input by the second input is applied, at an execution timing according to the arrangement position designated by the first input.

### FIELD

The present invention relates to a program creation device, a program creation method, and a program that create an operation program of a synchronous drive device.

### BACKGROUND

Conventionally, electronic cam control in which cam data is used to synchronize servo motors is commonly known as synchronous control on servo motors. The cam data is data that establishes a one-to-one correspondence between the phase of a master encoder attached to a master axis, that is an axis for which a synchronous control timing is determined, and the position of a slave axis. Further, electronic cam control in which cam data is divided into a plurality of sections to call each of the sections in any order and any number of times is well known (see Patent Literature 1, for example). It is considered that synchronous control including repetitions can be easily provided according to this electronic cam control.

### CITATION LIST

### Patent Literature

Patent Literature 1: Japanese Patent No. 3665008

### SUMMARY

### Technical Problem

Adjustment of the execution timing in the electronic cam control is performed generally by changing a synchronous phase between the master axis and the slave axis or by editing the cam data. The changing of the synchronous phase is completed by adjusting only one of parameters of each slave axis. However, when the cam data is edited, a partial change affects the entire cam data because the integrity of the data needs to be maintained. Therefore, a long time may be required for the adjustment process. When an execution timing of another axis to be synchronized, an operation command, or an execution timing of an I/O to be synchronized is affected by the edit of the cam data, the affected portion needs to be changed. Accordingly, a longer adjustment time is required. When there is no temporal allowance in the execution timing of each salve axis or when there is no allowance in the servo performance of each salve axis, various changes are often made to maintain the integrity. When a system is designed with an allowance in the execution timing of each slave axis and with an allowance in the servo performance of each slave axis, this decreases the likelihood for various changes to be made in the adjustment process. However, the performance (that is, a workload per unit time) of the entire control-target system is degraded. That is, in order to bring out the performance of the entire system, a user needs to compare the execution timings of the slave axes to each other or to adjust operation commands while reducing these allowances described above. Therefore, there is a problem in that when the edit of the cam data is performed, rework is often required, imposing a heavy load on the user.

In the technique described in Patent Literature 1, a method is employed in which cam data is divided into a plurality of sections to call each of the divided sections. Therefore, a change in a synchronous phase affects only a divided section of the cam data. Accordingly, the adjustment can be performed by changing the synchronous phase in more cases. However, according to the technique described in Patent Literature 1, after creating individual cam data, a user needs to perform the entire timing adjustment while comparing the individual cam data to each other among a plurality of slave axes. According to the technique described in Patent Literature 1, rework is required when the timing is adjusted by changing the cam data. Therefore, the problem of a heavy load on the user is not solved. Further, the technique described in Patent Literature 1 does not provide a method for assisting the adjustment.

The present invention has been achieved to solve the above problems, and an object of the present invention is to provide a program creation device, a program creation method, and a program that can create an operation program of a synchronous control device as easily as possible.

### Solution to Problem

According to an aspect of the present invention in order to solve the above-mentioned problems and achieve the object, there is provided a program creation device that creates an operation program of a synchronous control device that operates two or more controlled units in synchronization with each other, the program creation device including a processing unit that displays an edit screen, on which respective timing charts of the controlled units are arrayed in a vertical direction, on a display device, receives a first input for designating an arrangement position of a display object on the timing charts to arrange the display object at the arrangement position, displays the display object at the arrangement position designated by the first input on the timing charts, receives a second input including a designation of a type and an input of a parameter after displaying the display object, and generates an operation program for executing an operation command of the type designated by the second input, to which the parameter input by the second input is applied, at an execution timing according to the arrangement position designated by the first input.

### Advantageous Effects of Invention

The program creation device according to the present invention is capable of determining the execution timing of an operation command based on a display object arranged on the timing charts, and therefore can eliminate the need to adjust the execution timing in detailed settings. Accordingly, a user can create an operation program of the synchronous control device as easily as possible.

### BRIEF DESCRIPTION OF DRAWINGS

FIG. 1 is a diagram illustrating an example of a timing chart illustrating an operation of each axis.

FIG. 2 is an explanatory diagram of a system configured using a program creation device according to a first embodiment of the present invention.

FIG. 3 is a diagram illustrating a hardware configuration example of the program creation device according to the first embodiment.

FIG. 4 is a diagram illustrating a functional configuration of the program creation device according to the first embodiment.

FIG. 5 is a diagram illustrating an example of an edit screen displayed on a display device.

FIG. 6 is a flowchart illustrating an operation of the program creation device according to the first embodiment.

FIG. 7 is a diagram illustrating the edit screen in a state where a range designation has been input.

FIG. 8 is a diagram illustrating the edit screen in a state where an association input has been performed.

FIG. 9 is a diagram illustrating the edit screen in a state where a type of an operation command is being input.

FIG. 10 is a diagram illustrating the edit screen in a state of receiving an input for designating a template.

FIG. 11 is a diagram illustrating the edit screen in a state of receiving an input of a second parameter.

FIG. 12 is a diagram illustrating an edit screen according to a second embodiment of the present invention.

FIG. 13 is a flowchart illustrating an operation of a program creation device according to the second embodiment.

FIG. 14 is a flowchart illustrating an operation of a program creation device according to a third embodiment of the present invention.

FIG. 15 is a diagram illustrating a display manner of second straight lines according to a fourth embodiment of the present invention.

FIG. 16 is a diagram illustrating a display manner of the second straight lines in a state where an input for moving the second straight lines has been received.

### DESCRIPTION OF EMBODIMENTS

Exemplary embodiments of a program creation device, a program creation method, and a program according to the present invention will be explained below in detail with reference to the accompanying drawings. The present invention is not limited to the embodiments.

### First Embodiment

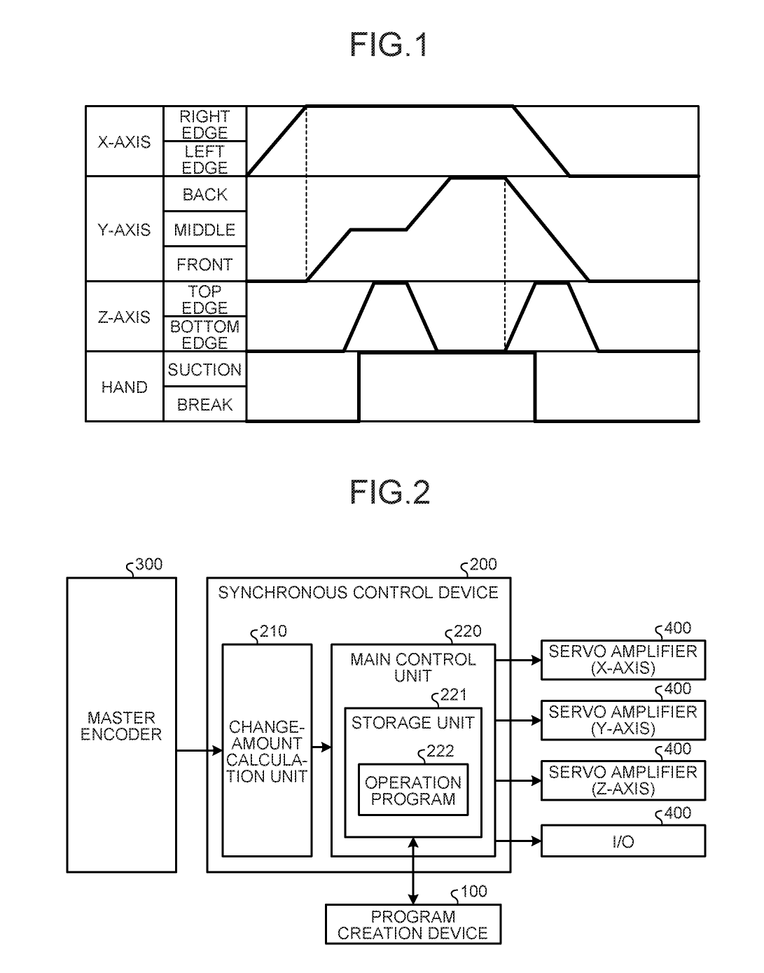

Generally, when an operation program for operating a synchronous control device is created, a timing chart illustrating an operation of each slave axis is used to schematically design the operation program, and thereafter a detailed operation program is described. Hereinafter, an “axis” means a slave axis. FIG. 1 is a diagram illustrating an example of timing charts illustrating operations of respective axes. In a timing chart, an operation of each axis or an operation of each I/O is described. The horizontal axis represents an amount used as a synchronization reference. For example, the angle of a master axis or the system time corresponds to this amount. An operation of each axis or an operation of each I/O is set using one or more operation commands. At the stage of creating a timing chart, each operation command is not set yet in detail. Instead, a start timing, an operating time, and an instruction value of each operation command are set approximately. In an operation of an I/O, changes are sometimes expressed with binary values such as ON/OFF. As an I/O, a hand is illustrated, which can have states expressed with binary values that are a state of “suction (ON)” and a state of “break (OFF)”. Generally, after the timing chart is created, an operation program is described based on this timing chart.

When a control-target system is large-sized, work is distributed among workers. Some of the workers perform operation design based on the timing chart while others describe the operation program. Because there are differences between specifics described in the timing chart and specifics that can be described in the operation program, there are specification discrepancies. For example, in descriptions of the timing chart, the operating time of each operation command is described with an approximate value and thus there is a discrepancy with an actual operating time. When parts between which the execution timings are to be matched are described clearly on the timing chart, it is possible to describe an operation program considering these parts. However, it is generally difficult to sufficiently describe parts between which the execution timings are to be matched, on the timing chart in advance based on the structure of an operation program. Further, there is a case where an operation command is started during execution of an operation command to another axis, or a case where a timing chart is described considering a delay in inputting an external signal or the like. It is generally difficult to transmit these design matters as described above from the timing chart to a control program without any discrepancy.

An operation program is often described in a form of calling a detailed operation command to each axis. In the case of electronic cam control, the position of a slave axis relative to the angle of a master axis is described as cam data. The synchronous control device generates an instruction value to the slave axis based on the angle of the master axis and the cam data. Therefore, during creation of cam data, the user needs to give consideration to prevent a torque shortage in a motor or the like at the time of practically executing the control. Conventionally, in the electronic cam control, each axis is synchronized with the angle of the master axis to realize synchronization of each axis. That is, cam data setting to each axis is performed separately from the timing adjustment among the axes. Therefore, at the time of creating cam data of each axis, while setting the cam data to prevent occurrence of a torque shortage described above or the like, it is necessary to adjust the timing with other axes. That is, cam data setting is a difficult process because it needs to consider both the torque and the timing.

According to a program creation device of a first embodiment, it is possible to perform schematic design of the entire device such as adjusting the execution timings among a plurality of axes on an edit screen, and thereafter set details of an operation command to each axis, in stages. Due to this configuration, after initially adjusting the execution timings among the axes, the user can set each operation command in detail while maintaining the result of adjustment of the execution timings. This can prevent rework of the detailed settings of an operation command from occurring during adjustment of the execution timings among the axes and can consequently reduce the adjustment time in the entire device.

FIG. 2 is an explanatory diagram of a system configured using the program creation device according to the first embodiment of the present invention. A synchronous control device 200 is connected to a master encoder 300 attached to a master axis and is also connected to a plurality of controlled units 400. The controlled units 400 each refer to a unit to which an instruction value is calculated and input by the synchronous control device 200. In a servo system, individual instruction values are respectively input to an X-axis, a Y-axis, and a Z-axis. In this servo system, a servo axis in the X-axis direction, a servo axis in the Y-axis direction, and a servo axis in the Z-axis direction correspond to the controlled units 400, respectively. An I/O also corresponds to the controlled unit 400. In the example of FIG. 2, a total of four controlled units 400 that are the servo axes in the X-axis, Y-axis, and Z-axis directions and the I/O are connected to the synchronous control device 200. The synchronous control device 200 operates the four controlled units 400 in synchronization with a signal from the master encoder 300. As a result, the four controlled units 400 can operate in synchronization with each other.

The synchronous control device 200 includes a change-amount calculation unit 210 and a main control unit 220. The main control unit 220 includes a storage unit 221 that has an operation program 222 stored therein. The change-amount calculation unit 210 calculates the angle (phase) of the master axis based on a signal from the master encoder 300. The main control unit 220 generates an instruction value to each of the controlled units 400 based on the angle of the master axis and the operation program 222. The main control unit 220 then outputs the generated instruction value to each of the controlled units 400. A part or the whole of the change-amount calculation unit 210 and the main control unit 220 can be implemented by software, hardware, or a combination thereof. “Being implemented by software” refers to being implemented by executing a predetermined program in a computer that includes an arithmetic unit and a main storage device.

A program creation device 100 of the first embodiment is connected to the synchronous control device 200. Based on an input from the user, the program creation device 100 can create the operation program 222 and set the operation program 222 in the storage unit 221. It is adequate that the program creation device 100 is not connected to the synchronous control device 200 during an operation of the synchronous control device 200.

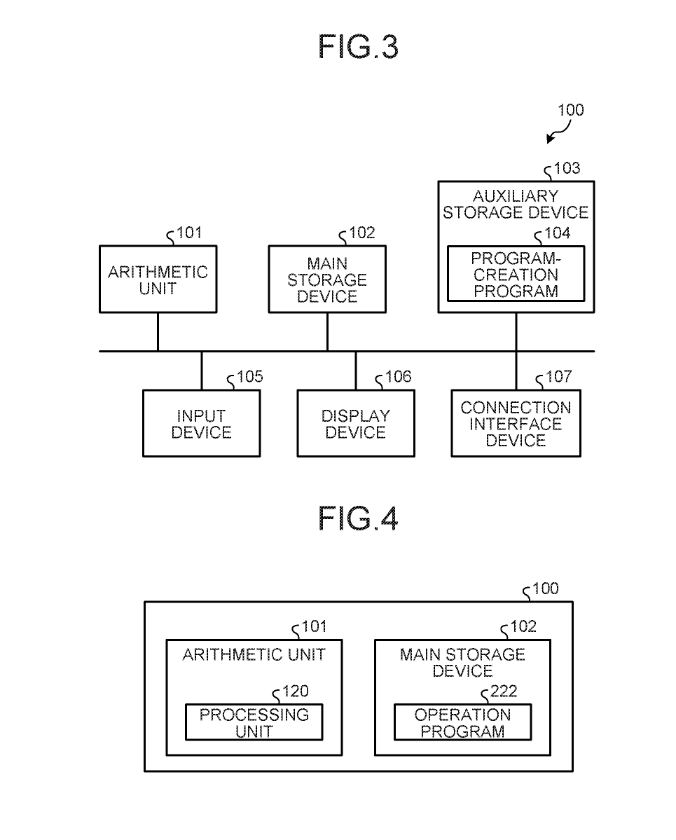

FIG. 3 is a diagram illustrating a hardware configuration example of the program creation device 100. The program creation device 100 includes an arithmetic unit 101, a main storage device 102, an auxiliary storage device 103, an input device 105, a display device 106, and a connection interface device 107. The arithmetic unit 101, the main storage device 102, the auxiliary storage device 103, the input device 105, the display device 106, and the connection interface device 107 are connected to each other through a bus.

The arithmetic unit 101 executes a program-creation program 104 that is a program for realizing a program creation method of the first embodiment. The display device 5 is a device that displays various types of information to be visually recognizable to the user and is a liquid crystal monitor, for example. The display device 106 displays an edit screen described later based on an instruction from the arithmetic unit 101. The input device 105 is configured to include a mouse and a keyboard, through which operation information from the user to the program creation device 100 is input. The operation information input to the input device 105 is transmitted to the arithmetic unit 101. The connection interface device 107 is an interface device to which the synchronous control device 200 is connected. A connection between the synchronous control device 200 and the program creation device 100 can be based on any standards.

The main storage device 102 is used as a program decompression area and a work area of the arithmetic unit 101. The main storage device 102 is a random access memory (RAM), for example. The auxiliary storage device 103 is a recording medium that has the program-creation program 104 stored therein in advance. The auxiliary storage device 103 is a read only memory (ROM), for example. The program-creation program 104 is read from the auxiliary storage device 103 and is loaded to the main storage device 102 through the bus. The arithmetic unit 101 executes the loaded program-creation program 104 in the main storage device 102. By executing the program-creation program 104 decompressed in the main storage device 102, the arithmetic unit 101 operates as a processing unit 120 described later. The operation program 222 is created and edited in the main storage device 102 by the arithmetic unit 101 and then is stored in the auxiliary storage device 103 to be nonvolatilized. The operation program 222 stored in the main storage device 102 or the auxiliary storage device 103 is transmitted to the synchronous control device 200 and set in the storage unit 221.

The program-creation program 104 can be configured to be stored in a computer connected to a network such as the Internet and to be downloaded via the network so as to be decompressed in the main storage device 102. The program-creation program 104 can also be configured to be provided or distributed via a network such as the Internet. Further, the recording medium that has stored therein the program-creation program 104 in advance can be a recording medium other than the ROM as long as it is a non-transitory tangible recording medium. For example, a hard disk drive (HDD), a solid state (SDD), a CD-ROM, a DVD-ROM, or a removable memory device is applicable as the recording medium that has stored therein the program-creation program 104 in advance. Further, the auxiliary storage device 103 can be implemented by a combination of these recording media.

FIG. 4 is a diagram illustrating a functional configuration of the program creation device 100 of the first embodiment. In the main storage device 102, the operation program 222 being edited is stored temporarily. The arithmetic unit 101 includes the processing unit 120. The processing unit 120 displays an edit screen that functions as a GUI on the display device 106 or causes specifics of the edit input through the edit screen to be reflected in the operation program 222 stored temporarily in the main storage device 102.

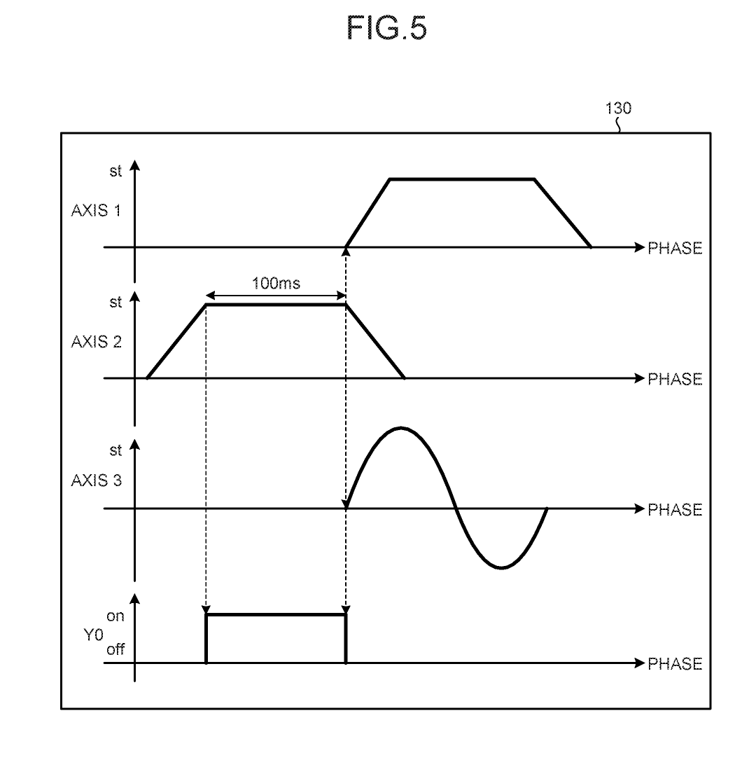

FIG. 5 is a diagram illustrating an example of the edit screen displayed on the display device 106 by the processing unit 120. On an edit screen 130, timing charts describing respective operations of three axes (axes 1 to 3) and of a device “Y0” that serves as an I/O are displayed to be arrayed in the longitudinal direction of the drawing sheet. The vertical axis represents amounts specific to the controlled units 400. The horizontal axis represents the angle (phase) of the master axis as a synchronization reference. The synchronization reference employed as the horizontal axis and the scale of the synchronization reference are common to the timing charts arrayed on the edit screen 130. As the vertical axis, the stroke (st) or the speed is employed, for example, when the controlled unit 400 is an axis. When the controlled unit 400 is an I/O, the amount expressed with binary values of ON/OFF is employed as the vertical axis. Each time the timing charts displayed on the edit screen 130 are edited using the input device 105, the processing unit 120 can cause specifics of the edit to be reflected in the operation program 222 stored in the main storage device 102. The processing unit 120 can cause specifics of the edit on the timing charts to be reflected in the operation program 222 at any timing. The operation program 222 can be in any format as long as the program can operate the synchronous control device 200. The operation program 222 can be either described in a predetermined program language or expressed by a process table. Further, the timing charts themselves can be treated as the operation program 222.

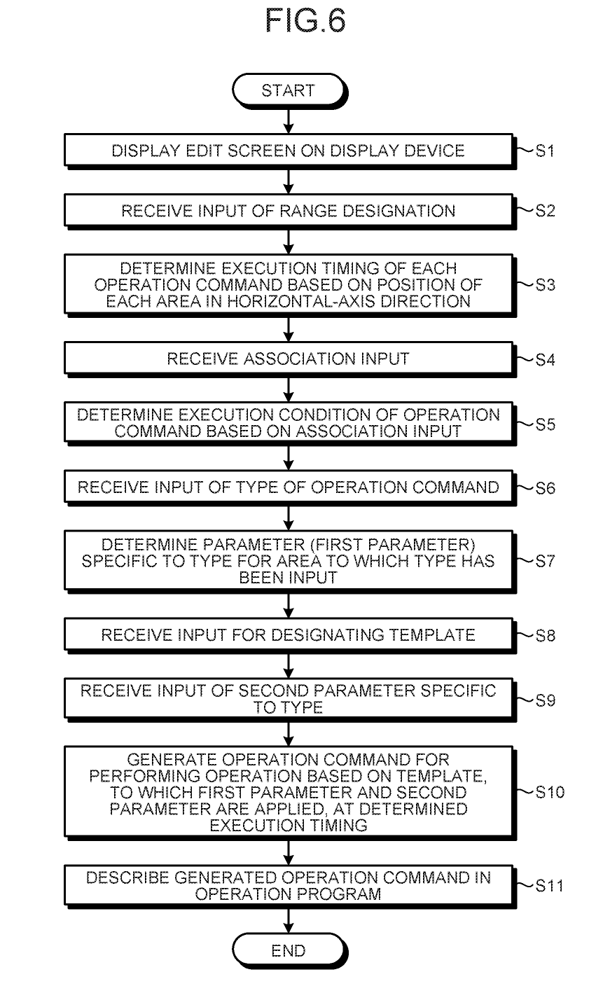

FIG. 6 is a flowchart illustrating an operation of the program creation device 100 according to the first embodiment. First, the processing unit 120 displays the edit screen 130 on the display device 106 (Step S1). By operating the input device 105, the user can set a setting item to each controlled unit 400 or can set a setting item common to the controlled units 400. Examples of the setting item include a label for identifying the controlled unit 400, a definition and a label of the vertical axis, and a definition and a label of the horizontal axis. As a synchronization reference, it is possible to designate any amount such as the angle of the master axis, the angle of a virtual servo, or a time in the system as long as the amount can be shared by the controlled units 400. As an example, the angle (phase) of the master axis is designated as the synchronization reference in this case. That is, the horizontal axis of each timing chart represents the angle (phase) of the master axis.

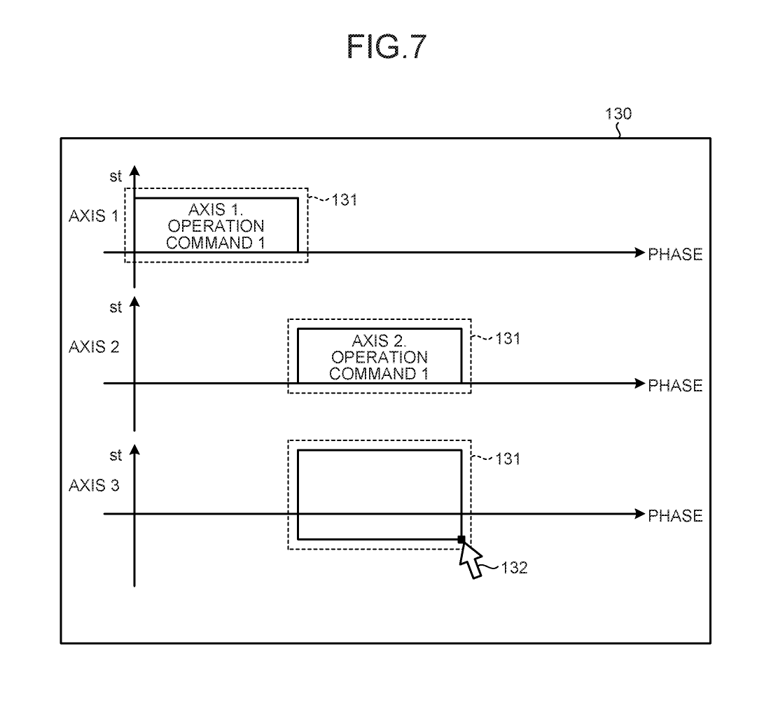

Subsequently, the processing unit 120 receives an input of a range designation (Step S2). FIG. 7 is a diagram illustrating the edit screen 130 in a state where the range designation has been input. The processing unit 120 draws a rectangular display object 131 in an individual area to which a range is designated (a display object 131). The input of the range designation includes an input of a first arrangement position in the horizontal-axis direction, and an input of a second arrangement position that is greater in the horizontal coordinate than the first arrangement position. The display object has a size extending exactly from the first arrangement position to the second arrangement position. The range designation can be input by any method. For example, the input of the range designation is performed by designating a start point (one of the first and second arrangement positions) using a mouse pointer 132 and thereafter dragging the mouse pointer 132 to designate a terminal point (the other of the first and second arrangement positions). Even after each display object 131 is drawn on the edit screen 130, it is still possible for the display object 131 to be moved or scaled up or down on the edit screen 130 by means of a drag-and-drop operation or by inputting a numerical value.

Each display object 131 corresponds to each individual operation command. There are various types of operation commands such as a cam command, a positioning command, a speed command, a time-fixing command, a torque command, and a gear command. At the time point at Step S2, the type of the operation command illustrated by each display object 131 is not determined yet.

The processing unit 120 determines the execution timing of each operation command based on the horizontal coordinate of each display object 131 (Step S3). For example, the processing unit 120 determines a phase indicated by the horizontal coordinate of the first arrangement position, as the start timing. Further, the processing unit 120 determines a phase indicated by the horizontal coordinate of the second arrangement position, as the termination timing.

Next, the processing unit 120 receives an input for associating the display objects 131 with each other (an association input) (Step S4). For example, when the start timing of one operation command is set at the termination timing of another operation command, an input is performed to associate two display objects 131 corresponding to the respective operation commands with each other. The association input can be performed by any method. For example, when two of the display objects 131 are selected successively, the processing unit 120 can recognize this input as an input to associate the two selected display objects 13 with each other. It is also adequate that, when an item “association” is selected from a context menu on the display objects 131 and thereafter two of the display objects 131 are selected successively, the processing unit 120 recognizes this input as an association input for associating the two selected display objects 131 with each other. The processing unit 120 can display a line segment, such as an arrow, connecting between a plurality of display objects 131 associated with each other by an association input to enable a relation between the display objects 131 to be visually recognized.

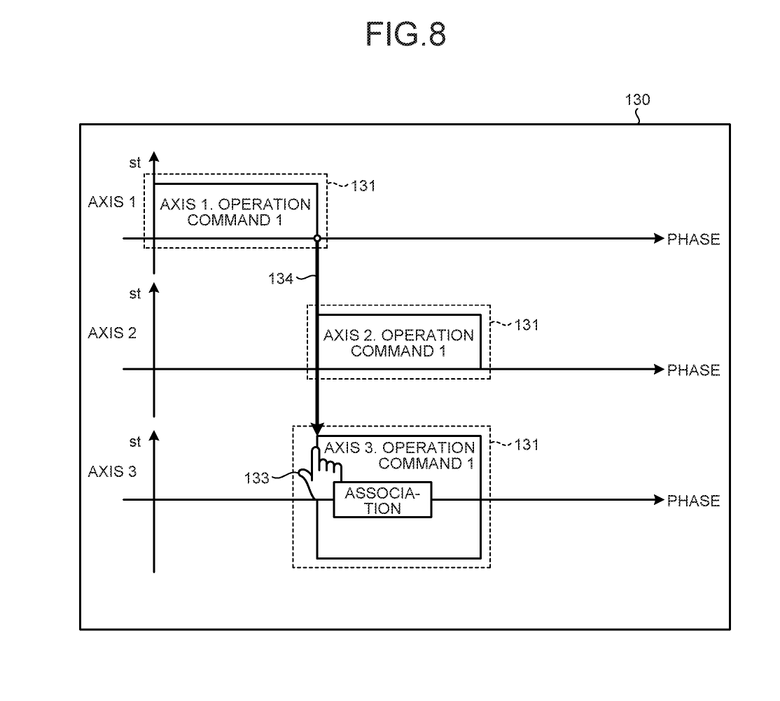

FIG. 8 is a diagram illustrating the edit screen 130 in a state where an association input has been performed. In an example of FIG. 8, an association input is performed using a mouse pointer 133, in which a display object 131 labeled as “axis 1. operation command 1” is associated with a display object 131 labeled as “axis 3. operation command 1”. An arrow 134 indicates the associated relation. With this association input, the termination timing of an operation command indicated by the display object 131 labeled as “axis 1. operation command 1” is set as the start timing of an operation command indicated by the display object 131 labeled as “axis 3. operation command 1”. Which one of the two selected display objects 131 whose termination timing is set as the start timing of the other one of the two display objects 131 is determined according to the positional relation in arrangement between the two display objects 131.

Subsequently, the processing unit 120 determines a condition for executing the operation commands based on the association input (Step S5). In the example of FIG. 8, the condition for executing the operation command indicated by the display object 131 labeled as “axis 3. operation command 1” is that its start timing is the termination timing of the operation command indicated by the display object 131 labeled as “axis 1. operation command 1”.

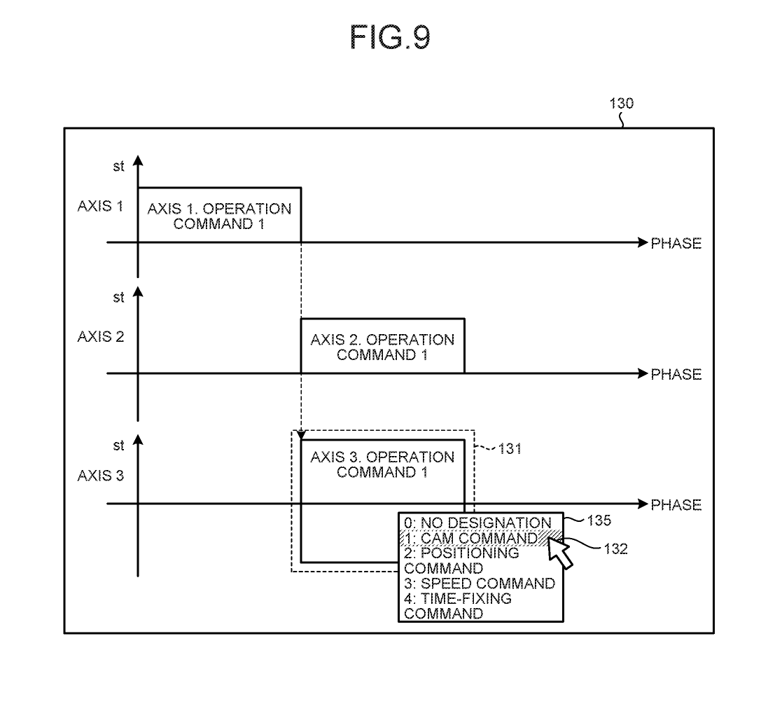

Next, the processing unit 120 receives an input of a type of the operation command (Step S6). FIG. 9 is a diagram illustrating the edit screen 130 in a state where a type of the operation command is being input. The processing unit 120 displays a context menu 135 that enables selection and input of one of “no designation”, “cam command”, “positioning command”, “speed command”, and “time-fixing command” in such a manner that the context menu 135 partially overlaps with the display object 131 labeled as “axis 3. operation command 1”. The mouse pointer 132 is then positioned near the display “cam command”. Based on the position of the mouse pointer 132, the processing unit 120 recognizes that the “cam command” is being selected and therefore displays the “cam command” as active.

Subsequently, based on the vertical-axis direction, the horizontal-axis direction, or both thereof of the display object 131 to which the type of the operation command has been input, the processing unit 120 determines the value of a parameter (a first parameter) specific to the type of the operation command (Step S7). The first parameter is a setting item of variable parameters that define the operation command for which the value can be determined based on the vertical-axis direction, the horizontal-axis direction, or both thereof. A second parameter described later is one of the remaining setting items for which the value cannot be determined based on the vertical-axis direction, the horizontal-axis direction, or both thereof. At Step S7, in the case of a cam command, for example, the processing unit 120 sets a stroke based on the vertical coordinates at the top and bottom edges of the display object 131, and sets a cycle length based on the horizontal coordinates at the left and right edges of the display object 131. In the case of a positioning command, the processing unit 120 sets an instruction position based on the vertical coordinates at the top and bottom edges of the display object 131. In the case of a speed command, the processing unit 120 sets an instruction speed based on the vertical coordinates at the top and bottom edges of the display object 131. However, it is also adequate that the processing unit 120 does not automatically determine the first parameter.

Next, the processing unit 120 receives an input for designating a template (Step S8). The template is an operation command pattern provided in advance, in which a typical operation is described using variable parameters (the first parameter and the second parameter). When values are set to the first and second parameters, the template can function as an operation command. For example, for a cam command, a template of a cam-curve pattern in which an axis is operated at a speed that varies in a trapezoidal form, or a cam-curve pattern in which an axis is operated at a constant acceleration is prepared. For example, in the cam-curve pattern, coordinates in which the path defines discontinuous points are prepared as the second parameters. An example of the coordinates in which the path defines discontinuous points is a pair of the phase and the stroke at a timing at which the speed varies from an accelerating state to a constant-speed state or at which the speed varies from a constant-speed state to an accelerating state. In the case of a cam-curve pattern in which an axis is operated at a speed that varies in a trapezoidal form, for example, coordinates that define a point at which the speed shifts from an accelerating state to a constant-speed state, and coordinates that define a point at which the speed shifts from a constant-speed state to a decelerating state, are set as the second parameters, thereby determining the path. Further, in the case of a positioning command, absolute positioning, relative positioning, interpolation positioning of a plurality of axes, or the like is prepared as a template. Furthermore, the template can include a curve defined by numerical parameters, such as an arc. The form of the arc is determined by setting the radius and the angle. In a template including an arc, numerical parameters for defining the arc, such as the radius and the angle of the arc, are prepared as the second parameters. In the case of an interpolation command to a plurality of axes, when axes simultaneously operated are set as the second parameters, an operation command that is an interpolation command being executed can be displayed also on the simultaneously-operated axes. Similarly to when the command type is designated, the processing unit 120 can automatically determine the second parameters.

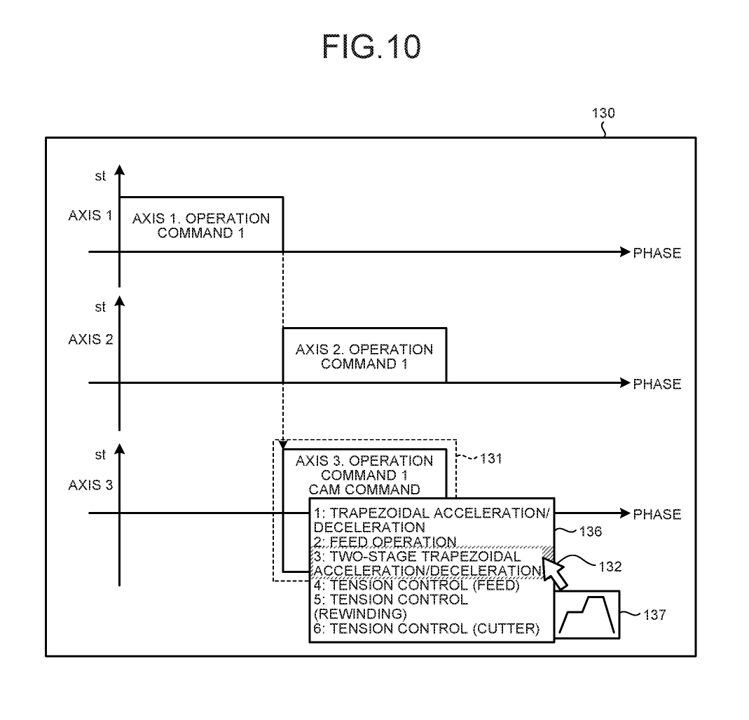

FIG. 10 is a diagram illustrating the edit screen 130 in a state of receiving an input for designating a template. The processing unit 120 displays a context menu 136 that enables selection and input of a template from among “trapezoidal acceleration/deceleration”, “feed operation”, “two-stage trapezoidal acceleration/deceleration”, “tension control (feed)”, “tension control (rewinding)”, and “tension control (cutter)” in such a manner that the context menu 136 partially overlaps with the display object 131 labeled as “axis 3. operation command 1”. The mouse pointer 132 is then placed near the display “two-stage trapezoidal acceleration/deceleration”. Based on the position of the mouse pointer 132, the processing unit 120 recognizes that the template “two-stage trapezoidal acceleration/deceleration” is being selected, and then displays “two-stage trapezoidal acceleration/deceleration” as active. Also, the processing unit 120 displays a schematic diagram of a cam-curve pattern with “two-stage trapezoidal acceleration/deceleration” on a window 137.

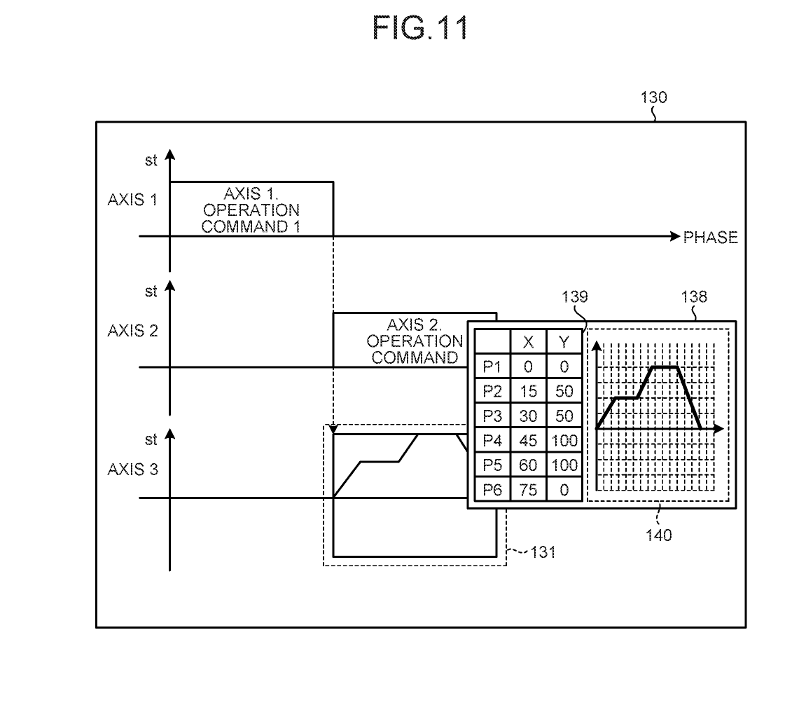

Next, the processing unit 120 receives an input of the second parameter (Step S9). At this time, the processing unit 120 can display an input screen specific to the template designated in the processing at Step S8. FIG. 11 is a diagram illustrating the edit screen 130 in a state where an input of the second parameter can be received. The processing unit 120 displays a second-parameter input screen 138 in such a manner that the input screen 138 partially overlaps with the display object 131 labeled as “axis 3. operation command 1”. The input screen 138 includes an input unit 139 and a detail display unit 140. The input unit 139 displays coordinates that define discontinuous points in the cam-curve pattern with “two-stage trapezoidal acceleration/deceleration” in an editable state. In the cam-curve pattern with “two-stage trapezoidal acceleration/deceleration”, a left edge (the horizontal coordinate of P1), a right edge (the horizontal coordinate of P6) and a top edge (the vertical coordinate of P4 and P5) are determined as the first parameters in the processing at Step S7, and displayed on the input unit 139. The user can input the remaining undetermined coordinates to the input unit 139, or can edit the coordinates displayed on the input unit 139. When the first parameters are not automatically determined, the user can input the first parameters in the processing at Step S9. The detail display unit 140 graphically displays a cam curve that is determined by applying the coordinates having been input to and displayed on the input unit 139 to the designated template. Based on the coordinates having been input to the input unit 139, the processing unit 120 generates image data of the cam curve, and displays the generated image data on the detail display unit 140. When the coordinates are changed, the processing unit 120 changes the cam curve, which is being displayed on the detail display unit 140, according to the change in the coordinates.

When a template includes a curve defined by numerical parameters, such as an arc, the numerical parameters are input as the second parameters to the input unit 139. At the time of generating image data, the processing unit 120 can calculate a curve using the second parameters. When a positioning command is designated as a template, a target position, a target speed, or the like is input as the second parameter to the input unit 139. When a template of tension control, or a template designed for special usage such as for a plant is designated, the input unit 139 is configured to enable a plurality of axes, a sensor input, and a signal output to be visually operated.

Subsequently, the processing unit 120 generates an operation command for performing an operation based on the template, to which the first parameter and the second parameter are applied, at the execution timing determined in the processing at Step S3 (Step S10). The processing unit 120 then describes the generated operation command in the operation program 222 (Step S11), thereby generating the operation program 222. After generating the operation program 222, the processing unit 120 ends its operation. The processing unit 120 can store the generated operation program 222 in the storage unit 221 according to an instruction input from the user.

The operations at Steps S2 to S10 can be individually performed on each operation command, or can be performed concurrently on all operation commands. The user can create an operation program for some of operation commands to some of axes, or can perform simplified settings of a plurality of operation commands (Steps S2 to S7) prior to detailed settings of each operation command (Steps S8 to S11). Further, the user can use the existing operation program to cause the processing unit 120 to perform desired processing among the operations at Steps S2 to S10. It is adequate that an association input is not received (Step S4) or the execution condition is not determined (Step S5).

As described above, according to the first embodiment, the program creation device 100 includes the processing unit 120 that displays, on the display device 106, the edit screen 130 on which respective timing charts of the controlled units 400 are arrayed in the vertical direction. Upon reception of a first input for designating an arrangement position of the display object 131 on the timing charts to arrange it at the arrangement position (Step S2), the processing unit 120 displays the display object 131 at the arrangement position designated by the first input on the timing charts. After displaying the display object 131, the processing unit 120 receives a second input including a designation of a type and an input of a parameter (Steps S6 and S9). The processing unit 120 then generates an operation program for executing an operation command of the type designated by the second input, to which the parameter input by the second input is applied, at the execution timing according to the arrangement position designated by the first input (Steps S10 and S11). The program creation device 100 is capable of adjusting the execution timing of an operation command based on an input for arranging the display object 131 on the timing charts. This can eliminate the need to set the execution timing at the stage of detailed design including determination of a parameter to each operation command. As a result, rework is prevented in the detailed design of operation commands, and therefore the user can easily create the operation program 222 of the synchronous control device 200.

It has been described that the processing unit 120 draws the display object 131 in a designated range to add an operation command, and thereafter receives an input of a parameter of the operation command including the type of the operation command. The processing unit 120 can be configured to receive an input for designating a template, and an input of a range designation of the display object 131 in the described order. First, after designating the type of a template, the user designates the range on the edit screen 130 to add an operation command. In the case of only setting the start position without designating the range, the processing unit 120 adds the display object 131 according to a parameter specific to each template. After the range where the display object 131 is arranged is designated, the processing unit 120 can automatically set the first parameter or the second parameter as described above. In this manner, after initially designating a template, the processing unit 120 can receive an input for adding an operation command. In that case, the user can reduce time and effort in the input process, as compared to the method in which the user sets a template to each of the display objects 131 on the edit screen 130.

In this example, it has been described that a template is added initially. However, the processing unit 120 can be configured to add a display object by a range designation after only designating the type of an operation command.

### Second Embodiment

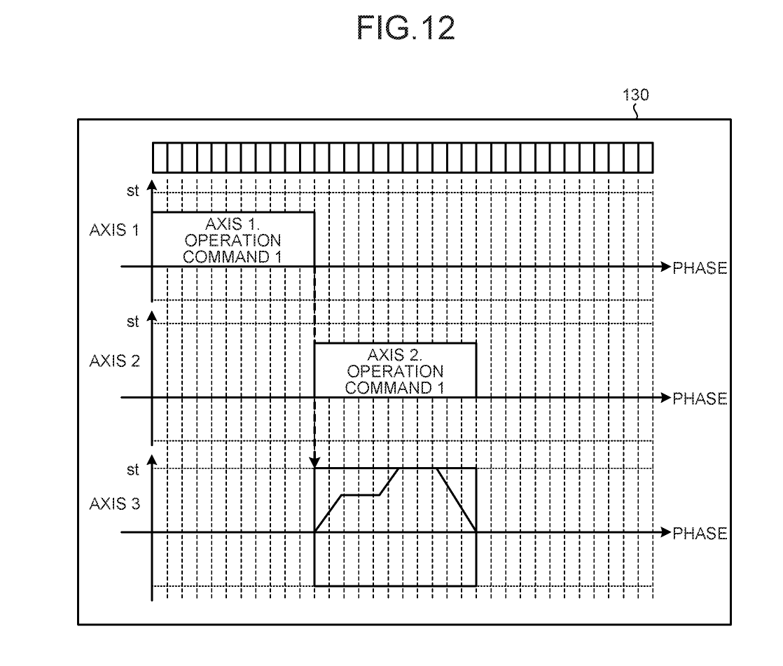

FIG. 12 is a diagram illustrating the edit screen 130 according to a second embodiment of the present invention. The processing unit 120 displays grid lines on the edit screen 130. The grid lines are made up of a plurality of straight lines (first straight lines) parallel to the vertical axis, and a plurality of straight lines (second straight lines) parallel to the horizontal axis. In FIG. 12, the first straight lines are displayed with equal spaces. Further, in FIG. 12, two second straight lines are displayed for each of the controlled units 400. Furthermore, the first straight lines and the second straight lines are displayed in a dotted-line manner. The first straight lines and the second straight lines can be displayed in any manner.

The two second straight lines for each of the controlled units 400 indicates a range where an input of a range designation is possible. That is, the user can input a range designation at Step S2 within the range defined by the second straight lines. An amount along the vertical axis of a timing chart of a servo axis indicates a stroke or a speed. The stroke or speed shown along the vertical axis is displayed using a ratio relative to the maximum stroke or a rated speed. It is general that the maximum stroke or a rated speed is input as a numerical value. Two second straight lines displayed on a timing chart of a servo axis indicate the maximum stroke and the minimum stroke, respectively. Two second straight lines displayed on a timing chart of an I/O indicate an ON-state and an OFF-state, respectively.

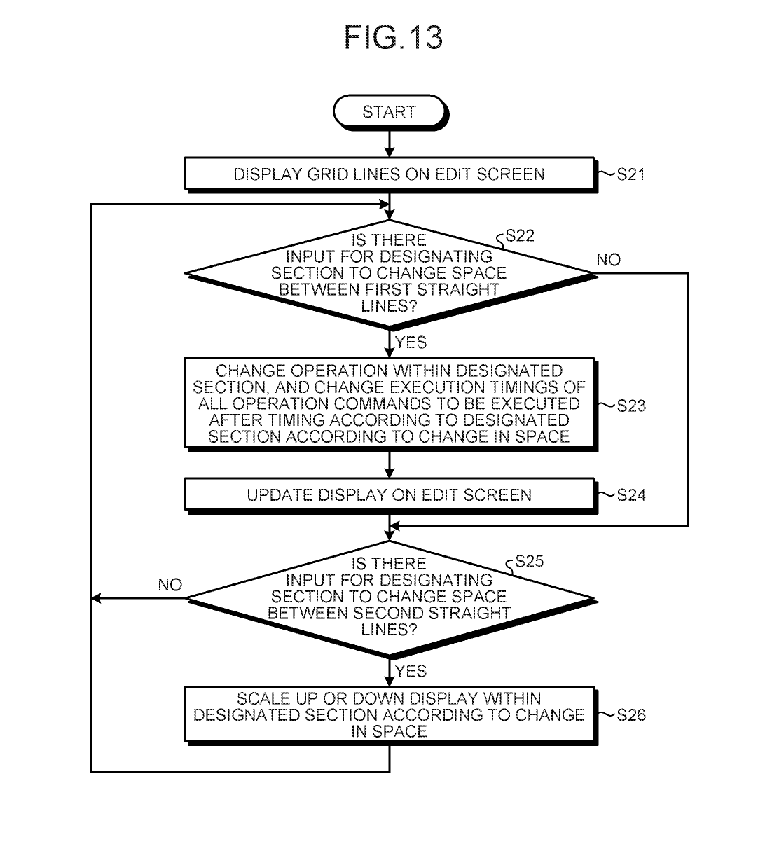

In the second embodiment, the processing unit 120 can receive an input for changing the space between the grid lines. FIG. 13 is a flowchart illustrating an operation of the program creation device 100 according to the second embodiment.

First, the processing unit 120 displays the grid lines on the edit screen 130 (Step S21). The user can perform an input for displaying the grid lines at any timing. Upon reception of an input for displaying the grid lines from the user, the processing unit 120 displays the grid lines. The processing unit 120 displays the first straight lines among the grid lines with a predetermined space, a user's designated space, or a previously-displayed space, for example.

Subsequently, the processing unit 120 determines whether there has been an input for designating a section to change the space between the first straight lines (Step S22). A section refers to an area defined by two adjacent straight lines or two straight lines that are not adjacent to each other. An input for changing the space is an input for moving a first straight line in the horizontal-axis direction. For example, when a first straight line at an edge of a section is dragged using a pointing device or when a numerical value that designates a space is input, the processing unit 120 can recognize this as an input for changing the space.

When there has been an input for changing the space between the first straight lines (YES at Step S22), the processing unit 120 changes an operation within a designated section and the execution timings of all operation commands to be executed after the operation within the designated section with regard to all axes, according to the change in the space (Step S23). That is, the processing unit 120 updates the operation program 222. The processing unit 120 then updates the display on the edit screen 130 (Step S24). In proportion to the space, the processing unit 120 changes an amount of change (that is, gradient) along the vertical axis per unit amount along the horizontal axis on the path within the designated section. For example, when the space in a designated section is changed from “10” to “20”, the space in the designated section is doubled, and the gradient of the path within the designated section is reduced by a factor of 0.5 as compared to that before the change. Operation commands, the execution timings of which are after the designated section, are all executed with a delay of “10” as compared to that before the change. In this manner, by changing the space in a designated section, all operation commands to all axes within the designated section, and the execution timings of all the operation commands to all axes, which are after the designated section, are changed uniformly according to the change in the space in the designated section. The execution timings of all the operation commands to all axes, which are after the designated section, are changed uniformly by the same amount. Therefore, a relation of the execution timings between any two of the operation commands on different axes, where the execution timings are after the designated section, remains unchanged before and after the change in the space. The space between the first straight lines is changed along with an operation change within the designated section. In processing at Step S23, the processing unit 120 changes the execution timing of an operation within the designated section, and changes parameters (the first parameter and the second parameter) that define the operation within the designated section. In this manner, the processing unit 120 updates the display on the edit screen 130, and updates the operation program 222, according to the change in the space between the first straight lines.

When there is no input for changing the space between the first straight lines (NO at Step S22), or after processing Step S23, the processing unit 120 determines whether there has been an input for designating a section to change the space between the second straight lines (Step S25).

When there has been an input for changing the space between the second straight lines (YES at Step S25), the processing unit 120 increases or reduces the display space within the designated section according to the input change in the space between the second straight lines (Step S26). In the case of a timing chart of an axis, the space between the second straight lines is changed to increase or reduce the display space without changing the stroke or the speed. In the case of a timing chart of an I/O, the amount along the vertical axis is designed to express binary values of ON/OFF. Therefore, in the case of a timing chart of an I/O, the display space is increased or reduced according to the change in the space between the second straight lines, identically to the timing chart of an axis. In this manner, the processing unit 120 updates the display on the edit screen 130 according to the change in the space between the second straight lines while not updating the operation program 222.

When there is no input for changing the space between the second straight lines (NO at Step S25), or after processing at Step S26, the processing unit 120 performs processing at Step S22 again.

The processing unit 120 can display or hide the grid lines based on an instruction from the user. The processing unit 120 can be configured to be capable of displaying/hiding the first straight lines and the second straight lines individually. Based on an instruction from the user, the processing unit 120 can change the space to rearrange the grid lines without changing the operation program 222. It is also adequate that at the time of starting display of the grid lines, the processing unit 120 automatically determines the display position of the grid lines in such a manner that the first straight line is positioned on a user's designated point. It is further adequate that at the time of displaying the grid lines, the processing unit 120 automatically determines the display position of the grid lines in such a manner that the first straight line is positioned on a point where the operation is distinctive (hereinafter “distinctive-operation point”). The distinctive-operation point is, for example, an operation-command start timing, the operation-command termination timing, a point at which the path changes discontinuously, or a point at which the movement direction or speed changes abruptly. When the user designates a first straight line, the processing unit 120 can clear display of the designated first straight line. When the first straight line is deleted, two sections on both sides of the first straight line before the deletion are merged into a single section.

As described above, according to the second embodiment, the processing unit 120 displays, on the edit screen 130, the first straight lines that are perpendicular to the horizontal axis of each of the timing charts and that are common to the timing charts, and therefore can receive an input for moving the first straight line in the horizontal-axis direction. Upon reception of an input for moving the first straight line in the horizontal-axis direction, the processing unit 120 uniformly changes the execution timings of operation commands that respectively correspond to the display objects 131 arranged on the respective timing charts. The user can collectively change operation commands to all axes and the execution timings of the operation commands, while maintaining the relation of the execution timings between the operation commands. Therefore, the time for adjusting the operation program 222 can be reduced.

### Third Embodiment

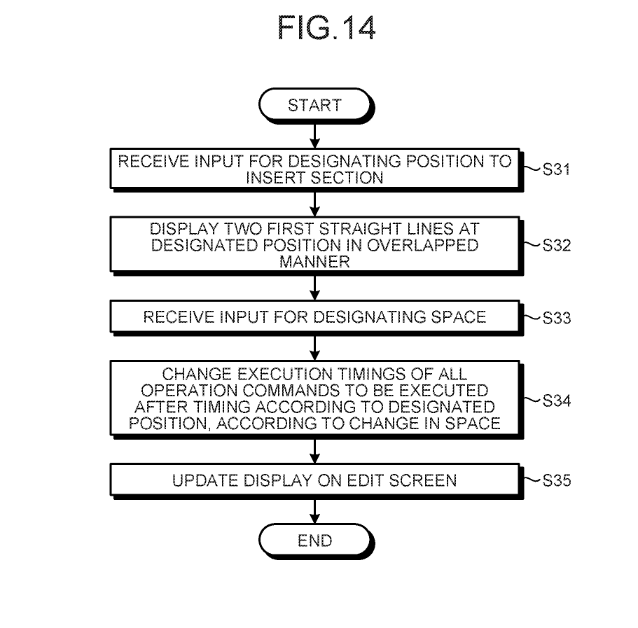

In a third embodiment, the processing unit 120 can insert an additional section at a user's designated position. After inserting a section with the space value of zero, the user changes the space of the inserted section, and therefore can adjust the execution timings of operation commands to all axes collectively and arbitrarily. FIG. 14 is a flowchart illustrating an operation of the program creation device 100 according to the third embodiment.

The processing unit 120 receives an input for designating a position to insert a section (Step S31). The processing unit 120 then displays two first straight lines at the designated position in an overlapped manner (Step S32). When a position on one of the first straight lines is designated, the processing unit 120 displays one additional first straight line at the designated position. When a position not on one of the first straight lines is designated, the processing unit 120 displays two additional first straight lines in an overlapped manner. The processing unit 120 can display two overlapping first straight lines in the same manner as, or in a manner different from, one first straight line.

Next, the processing unit 120 receives an input for designating a space between the two overlapping first straight lines (Step S33). The processing unit 120 then changes the execution timings of all operation commands to be executed after a timing indicated by the designated position with respect to all axes, according to the change in the space (Step S34). The processing unit 120 then updates the display on the edit screen 130 (Step S35). Any operation can be set within the inserted section. For example, the processing unit 120 sets an operation within the inserted section to have a constant value along the vertical axis within the section.

As described above, according to the third embodiment, the processing unit 120 can receive an input for designating the arrangement position and the space value equal to or greater than zero to insert an additional section. Upon reception of the input for inserting an additional section, the processing unit 120 inserts an additional section defined by two first straight lines with the designated space at the designated arrangement position on the edit screen 130. The processing unit 120 also changes the execution timings of all operation commands to be executed after the timing according to the designated arrangement position uniformly by the amount according to the designated space. Due to this operation, the user can adjust the execution timings of operation commands to all axes collectively and arbitrarily.

For example, there is a case where the completion timing of one operation command is set as the start timing of another operation command and where the user desires to delay the start timing of the another operation command without changing the completion timing of the one operation command. In that case, the user can delay the start timing of the another operation command by inserting an additional section at the completion timing of the one operation command. In this case, the execution timings of all operation commands to all axes, which are after the position of the inserted section, are delayed uniformly. There can be a plurality of sections with the space value of zero on the edit screen 130.

### Fourth Embodiment

In a fourth embodiment, the processing unit 120 displays a second straight line at any position on the timing chart of each controlled unit 400. For example, similarly to the processing of a first straight line in the second embodiment, the processing unit 120 can automatically determine the display position of a second straight line in such a manner that the second straight line is positioned on a distinctive-operation point. Alternatively, the processing unit 120 can determine the display position of a second straight line in such a manner that the second straight line is positioned on a user's designated point.

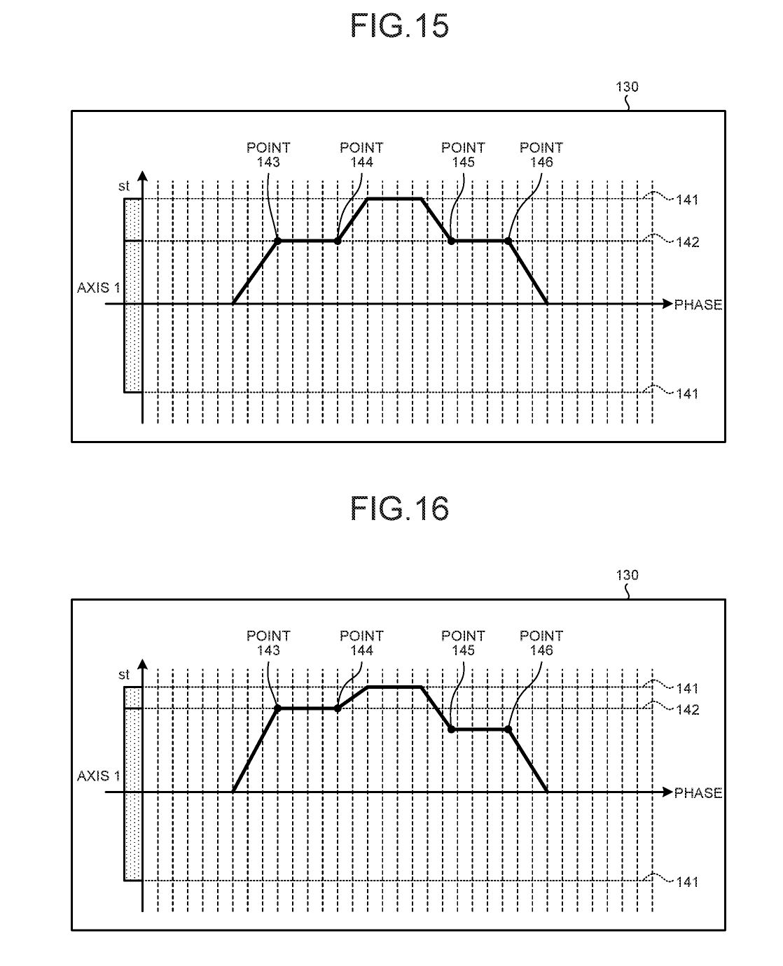

FIG. 15 is a diagram illustrating a display manner of second straight lines according to the fourth embodiment. Two second straight lines 141 are displayed in processing at Step S21. On a timing chart labeled as “axis 1”, a cam curve in a two-stage trapezoidal pattern is defined. This cam curve has at least four distinctive-operation points 143, 144, 145, and 146. The vertical coordinates of the points 143 to 146 are equal to each other. The processing unit 120 automatically detects the four points 143 to 146, and can display a second straight line 142 on which the four detected points 143 to 146 are positioned. Due to this display, in the case of a path with an intermediate value as the two-stage trapezoidal pattern, a second straight line is displayed so as to be positioned on the intermediate value. When the user designates a second straight line, the processing unit 120 can clear display of the designated second straight line identically to the first embodiment.

The processing unit 120 can receive an input for moving the second straight line 142 in the vertical-axis direction. Upon reception of an input for moving the second straight line 142 in the vertical-axis direction, the processing unit 120 changes the path of an operation command on an operation-command basis according to the change in position of the second straight line 142. The processing unit 120 updates the display on the edit screen 130 according to the input for moving the second straight line 142 in the vertical-axis direction.

The method for changing the path is determined according to the type of the operation command. For example, when the operation command is a cam command, the processing unit 120 changes the path of a section (a first section) having the second straight line 142 as the bottom border and the path of a section (a second section) having the second straight line 142 as the top border, respectively, according to the change in the position of the second straight line 142. Specifically, in the first section, a change amount along the horizontal axis per unit amount along the vertical axis within the first section is changed to be proportional to a change amount of the space in the first section. When the space in the first section is changed to be doubled as compared to that before the change, the processing unit 120 changes the gradient of the path in the first section by a factor of 0.5. The processing unit 120 performs the same change as that in the first section also in the second section. That is, the processing unit 120 changes the gradient of the path according to the change in the position of the second straight line. Even when the position of the second straight line 142 is changed, the processing unit 120 does not change the horizontal coordinates of the points 143 to 146 and changes the vertical coordinates of the points 143 to 146 according to the change in the position of the second straight line 142.

When the operation command is a positioning command, for example, the processing unit 120 changes the completion timing of the operation command, instead of changing the gradient of the path. This is because a target position is changed while the positioning-command start timing, the instruction speed, and the acceleration remain constant. However, if there is not a sufficient time for acceleration/deceleration, an operation section at the instruction speed cannot be ensured. Consequently, the processing unit 120 may change the gradient of the path.

When the vertical axis represents the speed instead of the stroke, a change in the position of the second straight line 142 corresponds to a change in the target speed. When the operation-command start timing or the position instruction is dragged and dropped using a pointing device, it is adequate that the processing unit 120 recognizes that it has been dropped on a grid line or an intersection of grid lines, which is nearest the drop position, and changes the position of a dragged target so as to correspond with the grid line or the intersection of grid lines, which is nearest the drop position.

The processing unit 120 can be configured to receive an input for associating some of the points 143 to 146 with the second straight line 142. Upon reception of an input for changing the position of the second straight line 142, the processing unit 120 changes the position of a point among the points 143 to 146, which is associated with the second straight line 142, in such a manner as to follow the change in the position of the second straight line 142. The processing unit 120 does not change the positions of points among the points 143 to 146, which are not associated with the second straight line 142.

The processing unit 120 can display a plurality of second straight lines at the same position in a overlapped manner. It is possible to associate the second straight lines displayed at the same position in an overlapped manner, with different points, respectively.

As described above, according to the fourth embodiment, upon reception of an input for moving a second straight line in the vertical-axis direction, the processing unit 120 changes the path of an input operation command according to the type of the operation command. Due to this operation, the user can easily adjust the operation command.

The processing unit 120 can be configured to receive an input for moving a point associated with a second straight line. When receiving an input for moving a point associated with a second straight line, the processing unit 120 changes the path in such a manner that the point associated with the second straight line follows movement of the second straight line and that points not associated with the second straight line do not follow movement of the second straight line. Due to this operation, the user can adjust the path by designating only some of points having the same intermediate value as a target for the change.

FIG. 16 is a diagram illustrating a changed path. FIG. 16 illustrates a timing chart in a state where an input is input for associating the points 143 and 144 on the timing chart in FIG. 15 with the second straight line 142 and moving the second straight line 142 in a positive direction of the vertical axis. As illustrated in FIG. 16, the points 143 and 144 move following the second straight line, and the points 145 and 146 do not move at all in contrast to the second straight line.

### Fifth Embodiment

In a fifth embodiment, the processing unit 120 can receive an input for designating two or more display objects 131 to change the space or the position. A designation of the display objects 131 can be input by any method. For example, through a key-operation input, the processing unit 120 shifts to a mode in which it can select a plurality of display objects 131. When an input is performed by pressing the display objects 131 using a pointing device in this mode, the processing unit 120 can recognize that the pressed display objects 131 have been designated.

After the display objects 131 are designated, an input for changing the start timing is performed by inputting a numerical value or a drag-and-drop operation. The processing unit 120 then changes the start timings of operation commands that respectively correspond to the designated display objects 131 according to the input for changing the start timing. For example, the processing unit 120 changes the start timings of the respective operation commands by a change amount according to the input for changing the start timing. The start timings of operation commands that respectively correspond to the designated display objects 131 are changed by the same amount. Therefore, the relation of the execution timings between the operation commands that respectively correspond to the designated display objects 131 remains unchanged before and after the change.

When the user performs an input for extension/reduction in the horizontal-axis direction, the processing unit 120 changes the operating period of each designated operation command at a common ratio according to the input. At the time of changing the operating period of each designated operation command, the processing unit 120 can change the operating period of each operation command with its start timing being fixed, or can change the operating period of each operation command without fixing its start timing. According to the change in the operating period of each operation command, the relation of the execution timings between the operation commands can be changed before and after the change in the operating period. When the user inputs a numerical value of the amount in the horizontal-axis direction, the processing unit 120 changes the operating period of each designated operation command to the input numerical value. Further, when the user inputs an instruction value, the processing unit 120 changes the instruction value of each designated operation command to the input instruction value.

As described above, according to the fifth embodiment, upon reception of an input for selecting two or more display objects 131 and changing the space between a first arrangement position and a second arrangement position, the processing unit 120 changes the operating period of each of the operation commands corresponding to all the selected display objects 131 according to the input. Due to this operation, the user can change the operating periods of any plural operation commands collectively.

Upon reception of an input for selecting two or more display objects 131 and changing their arrangement positions, the processing unit 120 changes the start timing of each of operation commands corresponding to all the selected display objects 131 according to the input. Due to this operation, the user can change the start timings of any plural operation commands collectively.

### Sixth Embodiment

According to a sixth embodiment, the processing unit 120 can receive an input for grouping two or more selected display objects 131. Upon reception of an input for grouping two or more selected display objects 131, the processing unit 120 stores therein the two or more selected display objects 131 as one group. Thereafter, the processing unit 120 can receive an input for changing the space between the arrangement positions at the rightmost and leftmost edges of the first and second arrangement positions of the two or more display objects 131 that constitute the group. Upon reception of an input for changing the space between the arrangement positions at both edges, the processing unit 120 changes the start timings and the operating times of respective operation commands that correspond to the display objects 131 that constitute the group in such a manner that a change rate of a time from the start timing of an operation command to be executed earliest among the respective operation commands to the start timing of each of the remaining operation commands, a change rate of the operating times of the respective operation commands, and a change rate of the spaces before and after the change due to an input for changing the space are equal. This enables the user to change the start timings and the operating times of a plurality of operation commands collectively without changing the order of execution timings among the operation commands.

### Seventh Embodiment

The processing unit 120 can display an additional work screen different from the edit screen 130 on the display device 106. The work screen is a screen enabling decompression and edit of an operation command created by the program-creation program 104 or by a program other than the program-creation program 104. When the user intends to edit desired operation commands individually, the user can copy a desired operation command to the work screen to be edited thereon, and then copy this operation command edited on the work screen to the edit screen 130. Because the user can edit an operation command on the work screen and copy the edited operation command to the edit screen 130, the user's load is reduced as compared to the case of creating all operation commands on the edit screen 130 when the user creates the operation program 222 including many similar operation commands.

In the first to seventh embodiments described above, it has been described that the processing unit 120 is implemented by software. However, a part or the whole of the processing unit 120 can be implemented by hardware or a combination of hardware and software.

### REFERENCE SIGNS LIST

100 program creation device, 101 arithmetic unit, 102 main storage device, 103 auxiliary storage device, 104 program-creation program, 105 input device, 106 display device, 107 connection interface device, 120 processing unit, 130 edit screen, 131 display object, 132, 133 mouse pointer, 134 arrow, 135, 136 context menu, 137 window, 138 input screen, 139 input unit, 140 detail display unit, 141, 142 second straight line, 143 point, 200 synchronous control device, 210 change-amount calculation unit, 220 main control unit, 221 storage unit, 222 operation program, 300 master encoder, 400 controlled unit.

1. A program creation device that creates an operation program of a synchronous control device that operates two or more controlled units in synchronization with each other, the program creation device comprising a processing unit that
displays an edit screen, on which respective timing charts of the controlled units are arrayed in a vertical direction, on a display device,
receives a first input for designating an arrangement position of a display object on the timing charts to arrange the display object at the arrangement position,
displays the display object at the arrangement position designated by the first input on the timing charts,
receives a second input including a designation of a type and an input of a parameter after displaying the display object, and
generates an operation program for executing an operation command of the type designated by the second input, to which the parameter input by the second input is applied, at an execution timing according to the arrangement position designated by the first input.

2. The program creation device according to claim 1, wherein
respective horizontal axes of the timing charts displayed on the edit screen represent a common synchronization reference, and
the processing unit
displays a first straight line on the edit screen, that are perpendicular to the horizontal axes of the timing charts and that are common to the timing charts,
receives a third input for moving the first straight line in a horizontal-axis direction, and
uniformly changes execution timings of respective operation commands that constitute the operation program and that correspond respectively to display objects arranged on the timing charts according to the third input.

3. The program creation device according to claim 2, wherein
the processing unit displays the first straight lines on the edit screen, where number of the first straight lines being equal to or greater than 2, and
the third input is an input for changing a space of a section defined by two first straight lines among the two or more first straight lines.

4. The program creation device according to claim 3, wherein
the processing unit
receives a fourth input for designating an arrangement position and a space value equal to or greater than zero to insert an additional section, and
inserts an additional section defined by two first straight lines with the designated space at the designated arrangement position on the edit screen, and also uniformly changes execution timings of all operation commands to be executed after a timing according to the designated arrangement position on the edit screen, by an amount according to the designated space.

5. The program creation device according to claim 1, wherein
the processing unit
displays a second straight line on the edit screen, that is parallel to the respective horizontal axes of the timing charts,
receives a fifth input for moving the second straight line in a vertical-axis direction on an operation-command basis, and
according to the fifth input and a type of an operation command to which the fifth input has been performed, changes a path of the operation command.

6. The program creation device according to claim 5, wherein
the operation command to which the fifth input has been performed is a position instruction, and
the processing unit
receives a sixth input for associating a point on a path of an operation command with the second straight line to be moved by the fifth input before the fifth input, and
when the fifth input is performed, changes the path of the operation command in such a manner that a point associated with the second straight line by the sixth input is moved so as to follow movement of the second straight line and that a point not associated with the second straight line by the sixth input does not follow movement of the second straight line.

7. The program creation device according to claim 1, wherein
an arrangement position designated by the first input includes a first arrangement position, and a second arrangement position that has a greater horizontal coordinate than that of the first arrangement position,
each display object has a size large enough to cover from a first arrangement position to a second arrangement position, and
the processing unit sets a timing according to the first arrangement position as a start timing of an operation command, and sets a timing according to the second arrangement position as a termination timing of an operation command.

8. The program creation device according to claim 7, wherein
the processing unit
receives a seventh input for selecting two or more display objects and also changing a space between the first arrangement position and the second arrangement position, and
according to the seventh input, changes operating times of respective operation commands that correspond to all display objects selected by the seventh input.

9. The program creation device according to claim 1, wherein
the processing unit
receives an eighth input for selecting two or more display objects and also changing arrangement positions, and
according to the eighth input, changes start timings of respective operation commands that correspond to all display objects selected by the eighth input.

10. The program creation device according to claim 6, wherein
the processing unit
receives a ninth input for grouping two or more display objects,
stores therein the two or more display objects as one group,
receives a tenth input for changing a space between arrangement positions located at both edges of first and second arrangement positions of the display objects that constitute the group, and
changes start timings and operating times of respective operation commands that correspond to the display objects that constitute the group, in such a manner that a change rate of a time from a start timing of an operation command to be executed earliest among the respective operation commands to a start timing of each of the remaining operation commands, a change rate of operating times of the respective operation commands, and a change rate of a space between arrangement positions due to the ninth input are equal before and after changing the space.

11. The program creation device according to claim 1, wherein the processing unit further displays, on the display device, a work screen for editing an operation command individually, which is different from the edit screen.

12. A program creation method for a computer including a display device to create an operation program of a synchronous control device that operates two or more controlled units in synchronization with each other, the program creation method comprising:
a step, performed by the computer, of displaying an edit screen, on which respective timing charts of the controlled units are arrayed in a vertical direction, on a display device;
a step, performed by the computer, of receiving a first input for designating an arrangement position of a display object on the timing charts to arrange the display object at the arrangement position;
a step, performed by the computer, of displaying the display object at the arrangement position designated by the first input on the timing charts;
a step, performed by the computer, of receiving a second input including a designation of a type and an input of a parameter after displaying the display object; and
a step, performed by the computer, of generating an operation program for executing an operation command of the type designated by the second input, to which the parameter input by the second input is applied, at an execution timing according to the arrangement position designated by the first input.

13. A computer-readable storage medium storing a program that causes a computer to create an operation program of a synchronous control device that operates two or more controlled units in synchronization with each other, the program causing the computer to execute
a step of displaying an edit screen, on which respective timing charts of the controlled units are arrayed in a vertical direction, on a display device,
a step of receiving a first input for designating an arrangement position of a display object on the timing charts to arrange the display object at the arrangement position,
a step of displaying the display object at the arrangement position designated by the first input on the timing charts,
a step of receiving a second input including a designation of a type and an input of a parameter after displaying the display object, and
a step of generating an operation program for executing an operation command of the type designated by the second input, to which the parameter input by the second input is applied, at an execution timing according to the arrangement position designated by the first input.
